(19) United States
(12) Patent Application Publication
(10) Pub. No.: US 2022/0073709 A1
(43) Pub. Date: Mar. 10, 2022

(54) RUBBER COMPOSITION HAVING ALUMINA COVERING AGENT

(71) Applicants: Jeremy John MEHLEM, Greenville, SC (US); Christopher PAPPAS, Greenville, SC (US); Constantine KHRIPIN, Greenville, SC (US); Compagnie Generale des Etablissements Michelin, Clermont-Ferrand (FR)

(72) Inventors: Jeremy John MEHLEM, Greenville, SC (US); Christopher PAPPAS, Greenville, SC (US); Constantine KHRIPIN, Greenville, SC (US)

(21) Appl. No.: 17/417,452

(22) PCT Filed: Dec. 11, 2019
(86) PCT No.: PCT/US2019/065672

§ 371 Date: Jun. 23, 2021

Related U.S. Application Data
(60) Provisional application No. 62/785,498, filed on Dec. 27, 2018.

(51) Int. Cl. C08L 9/06; C08K 3/22; C08K 9/04; C08K 3/06

(52) U.S. Cl. CPC C08L 9/06; C08K 3/22; C08K 2201/006; C08K 3/06; C08K 2003/2227; C08K 9/04

(57) ABSTRACT

A rubber composition based upon a cross-linkable rubber composition is provided that is in parts by weight per 100 parts by weight of rubber (phr), a diene rubber and a reinforcing filler that includes a reinforcing alumina filler with a nitrogen surface area of greater than 30 m2/g. The reinforcing alumina filler is at least 25 wt % of the reinforcing filler. An alumina covering agent is present and is either a benzilic acid derivative, a catechol derivative, or combinations thereof. The structure includes R1, R2, R3, and R4 that may be the same or different and are selected from a hydrogen, a C1 to C8 alkyl group, a C5 to C18 cycloalkyl group, or a C6 to C18 aryl group. A curing system is also present.

### BACKGROUND OF THE INVENTION

### Field of the Invention

This invention relates generally to rubber compositions useful for the manufacture of rubber articles and more particularly, to those that have been reinforced with alumina.

### Description of the Related Art

Reinforcement fillers are a necessary component found in rubber compositions. Such fillers provide rubber compositions with adequate strength and cohesion after they are vulcanized so that the rubber compositions are useful for manufacturing rubber articles. Carbon black and silica are both extremely useful reinforcing fillers and are found in many typical rubber compositions.

Other materials are also known to provide reinforcement to rubber compositions including, for example, alumina. U.S. Pat. No. 5,900,449 describes the use of alumina as a reinforcing filler in rubber compositions and also describes a method for making such alumina. Those skilled in the art continue to search for improved uses of alumina as a reinforcing filler.

### DETAILED DESCRIPTION OF PARTICULAR EMBODIMENTS

Particular embodiments of the present invention include rubber compositions and articles made from such rubber compositions that include an alumina reinforcing filler and a particular covering agent for the alumina. The covering agent covers at least a portion of the alumina surface and has surprisingly been found to improve the scorch and the processability of the green rubber composition.

As used herein, “phr” is “parts per hundred parts of rubber by weight” and is a common measurement in the art wherein components of a rubber composition are measured relative to the total weight of rubber in the composition, i.e., parts by weight of the component per 100 parts by weight of the total rubber(s) in the composition.

As used herein, elastomer and rubber are synonymous terms.

As used herein, “based upon” is a term recognizing that embodiments of the present invention are made of vulcanized or cured rubber compositions that were, at the time of their assembly, uncured. The cured rubber composition is therefore “based upon” the uncured rubber composition. In other words, the cross-linked rubber composition is based upon or comprises the constituents of the cross-linkable rubber composition.

The rubber compositions disclosed herein include a diene rubber. A “diene” elastomer or rubber is understood to mean, generally, an elastomer resulting at least in part (i.e. a homopolymer or a copolymer) from diene monomers having two double carbon-carbon bonds, whether conjugated or not. An “essentially unsaturated” diene elastomer is understood to mean a diene elastomer resulting at least in part from conjugated diene monomers and having a content of units of conjugated diene origin that is greater than 15 mol. %. A “highly unsaturated” diene elastomer falls within the category of an essentially unsaturated diene elastomer but is understood to mean a diene elastomer having a content of units of conjugated diene origin that is greater than 50 mol. %.

An “essentially saturated” diene elastomer is understood to mean a diene elastomer having a low or very low content of units of diene origin, which is always less than 15%. Thus, for example, an elastomer such as a butyl rubber, a copolymer of a diene and of an alpha-olefin of the ethylene-propylene diene terpolymer (EPDM) type or a copolymer of an ethylene-vinyl acetate type do not fall within the definition of an essentially unsaturated diene elastomer. Particular embodiments of the rubber compositions disclosed herein do not include any essentially saturated diene elastomer. Other embodiments may optionally include a low quantity of an essentially saturated diene elastomer such embodiments including, for example, less than 1 wt %, less than 3 wt % or less than 5 wt % of the total elastomer content. Yet other embodiments may include up to 100 phr of such rubber components according to the usage intended for the rubber formulation.

Particular embodiments of the rubber compositions disclosed herein include only highly unsaturated diene rubbers as useful components, especially those that are intended for use in tires as a tire component other than the inner liner of the tire. As known by one having ordinary skill in the art, a highly unsaturated diene elastomer may, for example, be obtained from:

(a)—any homopolymer obtained by polymerisation of a conjugated diene monomer having between 4 and 12 carbon atoms;

(b)—any copolymer obtained by copolymerization of a conjugated diene with each other or with a vinyl-aromatic compound having between 8 and 20 carbon atoms.

Suitable conjugated dienes include, for example, 1,3-butadiene, 2-methyl-1,3-butadiene, 2,3-di(C₁-C₅ alkyl)-1,3-butadienes such as 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene and 2,4-hexadiene. Suitable vinyl-aromatic compounds include, for example, styrene, ortho-, meta- and para-methylstyrene, the commercial mixture “vinyltoluene”, para-tert.-butylstyrene, methoxystyrenes, chlorostyrenes, vinylmesitylene, divinylbenzene and vinylnaphthalene.

The copolymers may contain between 99% and 20% by weight of diene units and between 1% and 80% by weight of vinyl-aromatic units. The elastomers may have any microstructure, which is a function of the polymerisation conditions used, in particular of the presence or absence of a modifying and/or randomising agent and the quantities of modifying and/or randomising agent used. The elastomers may for example be block, statistical, sequential or microsequential elastomers, and may be prepared in dispersion or in solution; they may be coupled and/or starred or alternatively functionalised with a coupling and/or starring or functionalizing agent.

In particular embodiments of such rubber compositions, the diene elastomer of the composition is highly unsaturated and may be selected, for example, from a polybutadiene (BR), a synthetic polyisoprene (IR), a natural rubber (NR), a butadiene copolymer, an isoprene copolymer, a styrene-butadiene copolymer (SBR), a butadiene-isoprene copolymer (BIR), an styrene-isoprene copolymer (SIR), a styrene-butadiene-isoprene copolymer (SBIR) and mixtures thereof. Particular embodiments of the rubber composition may include only natural rubber as the highly unsaturated diene elastomer or alternatively, only NR, IR, BR, SBR or combinations thereof.

As noted above, in addition to the rubber component, particular embodiments of the rubber compositions disclosed herein further include a reinforcing filler, such reinforcing filler including at least in part a reinforcing alumina. The reinforcing alumina that is useful in such embodiments is any alumina having a BET surface area ranging from between 30 m²/g and 400 m²/g or alternatively, between 30 m²/g and 250 m²/g, between 80 m²/g and 250 m²/g or between 80 m²/g and 150 m²/g. Other characteristics useful for particular embodiments may include a high proportion of Al—OH surface reactive functional groups, as may be found, for example, in gamma, delta or theta types of alumina. Of the different alumina types, particular embodiments of the rubber compositions disclosed herein may include only gamma-type alumina.

The mean particle size of the useful reinforcing alumina may be, for example, no more than 500 nm or alternatively, no more than 400 nm, no more than 200 nm or no more than 100 nm. When the size of the alumina particles is greater than 500 nm the reinforcing activity of the alumina is very greatly reduced. Such particle size may be determined, after ultrasonic deagglomeration, with the aid of a Vibracell Bioblock (600 W) ultrasound generator equipped with a ½-inch diameter probe, by centrifugal sedimentation. The particles may also be characterized as having high dispersibility, i.e., sufficient for few aggregates larger than a few microns to be seen by reflection in optical microscopy on a section of rubber mix.

Particular embodiments of the rubber compositions disclosed herein may include between 20 phr and 300 phr of the reinforcing alumina and can be employed alone or in the presence of other reinforcing fillers like, for example, carbon black or a reinforcing silica or any other reinforcing filler. The improvement in the properties is proportionally greater the higher the proportion of the specific alumina in relation to the other fillers which may be present. The alumina is preferably employed in a proportion which is a majority in relation to the other fillers; the improvement in the performance being greatest when all of the filler consists of the specific alumina. For example, alumina CR 125 marketed by Baikowski Chemie France is suitable as specific alumina which can be employed in the composition in accordance with the invention. This material has a BET of 105 m²/g, a density of 3.7 g/cm³, a mean particle size of 300 nm and has a gamma crystalline phase content of >96%. Another example of a suitable alumina is AKP-G15 marketed by Sumitomo Chemical. This material has a BET of 164 m²/g, a mean particle size of 29 nm and has a gamma crystalline phase. Another example of a suitable alumina is Alox-01-NW.005N marketed by American Elements of California. This material has a BET of 130 m²/g. The BET surface measurement is performed according to the Brunauer-Emmett-Teller method described in the “Journal of the American Society” Vol. 60, page 309, February 1938 and corresponding to NFT standard 45007 (November 1987).

As noted above, particular embodiments of the rubber compositions disclosed herein includes a reinforcing filler that has at least in part the reinforcing alumina. Particular embodiments may include an additional reinforcing filler. Any additional reinforcing filler known to those skilled in the art may optionally be used in the rubber composition with the reinforcing alumina. Silica and carbon black are both well-known reinforcing fillers and are examples of reinforcing fillers that may optionally be used with the alumina reinforcing filler. Some embodiments include only the reinforcing alumina as the reinforcing filler, while other embodiments may limit the additional reinforcing filler, if any, to only carbon black, to only silica or in other embodiments, to combinations thereof.

Suitable carbon blacks are not particularly limited and may include, for example, N234, N299, N326, N330, N339, N343, N347, N375, N550, N660, N683, N772, N787, N990 carbon blacks. Suitable silica fillers are not particularly limited and may include, for example, any precipitated or pyrogenic silica having a BET surface area and a specific CTAB surface area both of which are less than 450 m²/g or alternatively, between 30 and 400 m²/g. Highly dispersible precipitated silicas (referred to as “HDS”) may be useful in particular embodiments of such rubber compositions disclosed herein, wherein “highly dispersible silica” is understood to mean any silica having a substantial ability to disagglomerate and to disperse in an elastomeric matrix. Such determinations may be observed in known manner by electron or optical microscopy on thin sections. Examples of known highly dispersible silicas include, for example, Perkasil KS 430 from Akzo, the silica BV3380 from Degussa, the silicas Zeosil 1165 MP and 1115 MP from Rhodia, the silica Hi-Sil 2000 from PPG and the silicas Zeopol 8741 or 8745 from Huber.

The amount of reinforcing fillers in particular embodiments of the rubber compositions disclosed herein may range between 30 phr and 300 phr or alternatively between 50 phr and 275 phr, between 45 phr and 200 phr, between 45 phr and 150 phr, between 50 phr and 125 phr or between 50 phr and 100 phr. Other ranges may be suitable for other embodiments as is known by those having skill in the art.

The amount of the reinforcing alumina for particular embodiments is at least 25 wt % of the total amount of reinforcing filler in the rubber composition or alternatively, at least 30 wt %, at least 50 wt %, at least 60 wt %, at least 75 wt %, at least 85 wt %, at least 90 wt % or at least 95 wt %. As noted above, particular embodiments of such rubber compositions may include 100 wt % of the reinforcing filler as the alumina reinforcing filler.

As is well known in the art, when silica is added to the rubber composition, a proportional amount of a silane coupling agent is also added to the rubber composition. Examples of suitable silane coupling agents include 3,3′-bis(triethoxysilylpropyl) disulfide (marketed as Si-266 by Evonik) and 3,3′-bis(triethoxysilylpropyl) tetrasulfide (marketed as Si69 by Evonik). Such materials may also be added to particular embodiments of the rubber compositions disclosed herein even when there is no silica present as a reinforcing filler since the material will also act as a coupling agent with the alumina. The silane may be added, for example, in an amount of between 3 wt % and 15 wt % of the reinforcing filler that is alumina and silica if any silica is present.

In addition to the rubber components and the reinforcing fillers, particular embodiments of the rubber compositions disclosed herein further include a covering agent for the reinforcing alumina. The covering agent covers at least a portion of the alumina surface and has surprisingly been found to improve the scorch and the processability of the green rubber composition.

Suitable alumina covering agents include benzilic acid derivatives, catechol derivatives, and combinations thereof having structures, respectively, as follows:

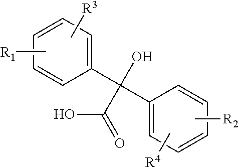

wherein R¹, R², R³, and R⁴ may be the same or

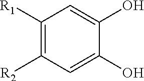

different and are selected from a hydrogen, a C₁ to C₈ alkyl group, a C₅ to C₁₈ cycloalkyl group, or a C₆ to C₁₈ aryl group. Alternatively the alkyl group may be selected from C₁ to C₆ group and/or the cycloalkyl group may be selected from a C₅ to C₁₀ group and/or the aryl group may be selected from a C₆ to C₁₂ group. Is it noted that in particular embodiments, these moieties bonded to the rings provide a degree of shielding and are compatible with the rubber compounds in which they are mixed.

In particular embodiments, the benzilic acid derivative may be described as having the R¹ and R³ moieties separated by at least one carbon on the ring to which they are bonded and/or the R² and R⁴ moieties separated by at least one carbon on the ring to which they are bonded. In other embodiments, the R¹ and R³ moieties are separated by two carbons on the ring to which they are bonded and/or the R² and R⁴ moieties are separated by at two carbons on the ring to which they are bonded. In still other embodiments, the R¹ and R³ moieties are not separated by any carbon on the ring to which they are bonded and/or the R² and R⁴ moieties are not separated by any carbon on the ring to which they are bonded.

One example of a suitable alumina covering agent is 3,5 di-tert-butylcatechol (DTBC), a catechol derivative, wherein both R¹ and R² are a t-butyl moiety and wherein the tertiary butyl moieties are separated by one carbon on the ring. Another example of a suitable alumina covering agent is benzilic acid, wherein R¹, R², R³, and R⁴ are hydrogen. Both of these covering agents are available from Sigma Aldrich.

The alumina covering agent may be added to the rubber compositions in an amount proportional to the amount of the reinforcing alumina. For example, the alumina covering agent may be added in an amount of between 0.5 wt % and 15 wt % based on the total weight of the reinforcing alumina or alternatively between 1 wt % and 15 wt %, between 1 wt % and 12 wt %, between 1 wt % and 10 wt % or between 3 wt % and 8 wt % based on the total weight of the reinforcing alumina.

In addition to the rubber components, the reinforcing filler that includes alumina, and the alumina covering agent, particular embodiments of the rubber compositions disclosed herein further include a curing system. The curing system may, for example, be based on a sulfur curing system with sulfur and one or more accelerators or may be based on a peroxide curing system with an organic peroxide such as di-cumyl peroxide or tert-butyl cumyl peroxide or other well-known organic peroxides suitable for curing rubber compositions. Particular embodiments of the rubber compositions disclosed herein may be limited to sulfur curing systems.

As known by those skilled in the art, sulfur may take the form of free sulfur, insoluble sulfur, soluble sulfur and/or provided by a sulfur donor. Sulfur donors, as known in the art, contribute sulfur to the curing process. An example of a sulfur donor is caprolactam disulfide, which is sold under the trade name RHENOGRAN CLD-80 by Lanxess. In particular embodiments, sulfur may be added in an amount ranging, for example, between 0.3 and 3 phr or alternatively between 0.5 phr and 2 phr or between 0.5 and 1.5 phr.

Accelerators are well known and typically are chosen from the basic families of accelerators based on their speed of vulcanization: guanidines (medium) such as diphenyl guanidine (DPG); thiazoles (semi-fast) such as 2-mercaptobenzothiazole (MBT) and 2-mercaptobenzothiazyl disulfide (MBTS); sulphenamides (fast) such as N-cyclohexyl-2-benzothiazolesulphenamide (CBS), N,N-dicyclohexyl-2-benzothiazolesulphenamide (DCBS) and N-tert-butyl-2-benzothiazole-sulphenamide (TBBS); thiurams (very fast) such as tetramethylthiuram monosulfide (TMTM); and dithiocarbamates (super-fast) such as zinc dimethyldithiocarbamate (ZDMC) and zinc diethyldithiocarbamate (ZDEC).

The vulcanization system may further include various known vulcanization activators, such as zinc oxide and stearic acid.

Other additives can be added to the rubber compositions disclosed herein as known in the art. Such additives may include, for example, some or all of the following: antidegradants, antioxidants, fatty acids, waxes, stearic acid and zinc oxide. Examples of antidegradants and antioxidants include 6PPD, 77PD, IPPD, DAPD and TMQ and may each be added to rubber compositions in an amount, for example, of from 0.5 phr and 7 phr. Zinc oxide may be added in an amount, for example, of between 1 phr and 6 phr or alternatively, of between 1.5 phr and 4 phr. Stearic acid may be added in an amount, for example, of between 1 phr and 4 phr or alternatively between 1 phr and 2 phr. Waxes may be added in an amount, for example, of between 0.5 phr and 5 phr or alternatively between 0.5 phr and 1.5 phr.

In addition, particular embodiments may include a plasticizer system that comprises a liquid plasticizer, a plasticizing resin or combinations thereof. Such plasticizers are well known in the art and include, for example, vegetable oils, naphthenic oils, hydrocarbon resins such as C5-C9 resins typically made from petroleum stocks and polylimonene resins. These are merely examples and such plasticizers may be included, for example, in amounts of between 4 phr and 70 phr.

The rubber compositions that are embodiments of the present invention may be produced in suitable mixers, in a manner known to those having ordinary skill in the art, typically using two successive preparation phases, a first phase of thermo-mechanical working at high temperature, followed by a second phase of mechanical working at lower temperature.

The first phase of thermo-mechanical working (sometimes referred to as “non-productive” phase) is intended to mix thoroughly, by kneading, the various ingredients of the composition, with the exception of the vulcanization system. It is carried out in a suitable kneading device, such as an internal mixer or an extruder, until, under the action of the mechanical working and the high shearing imposed on the mixture, a maximum temperature generally between 80° C. and 175° C., more narrowly between 130° C. and 165° C., is reached.

After cooling of the mixture, a second phase of mechanical working is implemented at a lower temperature. Sometimes referred to as “productive” phase, this finishing phase consists of incorporating by mixing the vulcanization (or cross-linking) system (sulfur or other vulcanizing agent and accelerator(s)), in a suitable device, for example an open mill. It is performed for an appropriate time (typically between 1 and 30 minutes, for example between 2 and 10 minutes) and at a sufficiently low temperature lower than the vulcanization temperature of the mixture, so as to protect against premature vulcanization.

The rubber compositions can then be formed into useful articles, including tire components such as a tire tread, under tread, sidewall component or the rubber covering of the tire reinforcements. Other rubber articles may also be formed from such rubber compositions, including conveyor belts, motor mounts, rubber mats and so forth.

The invention is further illustrated by the following examples, which are to be regarded only as illustrations and not delimitative of the invention in any way.

The torque that is used to determine the curing law of the green rubber formulation was measured with a model RPA2000 Rubber Process Analyzer (marketed by Alpha Technologies) measuring device. A mass of green rubber ranging from 5.5 g to 6.5 g is introduced into the RPA cavity and then compressed between two dies, a stationary die and a vibrating die. The strain during the curing procedure is a sinusoidal shearing at a frequency of 1.67 Hz and an angle amplitude of 0.2° (0.5-1% of strain). The torque (kPa) necessary to keep a constant deformation on the rubber sample at 150° C. is measured. As the rubber cures, the necessary torque increases over time so that the evolution of the torque over time provides the curing law at the selected temperature.

### Example 1

This example demonstrates the effect of the alumina covering agent on the rubber compositions. Rubber compositions were prepared using the components shown in Table 1. The amount of each component making up the rubber compositions are provided in parts per hundred parts of rubber by weight (phr).

TABLE 1
Formulations

| | W1 | W2 | F1-F4 | F5-F8 |
|---|---|---|---|---|
| SBR | 100 | 100 | 100 | 100 |
| Silica | 45 | 0 | 0 | 0 |
| Alumina | 0 | 74 | 74 | 74 |
| Silane | 4.5 | 3 | 3 | 3 |
| Alumina Cover Agent | 0 | 0 | 1.5-6.0 | 1.5-6.0 |
| 6PPD | 2 | 2 | 2 | 2 |
| DPG | 1.8 | 0 | 0 | 0 |
| Stearic Acid | 1.2 | 1.2 | 1.2 | 1.2 |
| ZnO | 2.0 | 2.0 | 2.0 | 2.0 |
| CBS | 1.5 | 1.5 | 1.5 | 1.5 |
| Sulfur | 1.5 | 1.5 | 1.5 | 1.5 |

The SBR elastomer was 27% styrene with a Mn of 118,700 and the butadiene portion having 24% vinyl, 46% trans and 30% cis bonds. The silica was Zeosil 1165 marketed by Solvay, a highly dispersible silica having a BET of 160 m²/g. The silane coupling agent was Si69 for W1 and was Si-266 for all the other formulations, both being a bifunctional, sulfur containing organosilane marketed by Evonik.

The alumina was CR 125 marketed by Baikowski Chemie and had a BET of 105 m²/g, a density of 3.7 g/cm³, a mean particle size of 300 nm and a gamma crystalline phase content of >96%.

The inventive formulations F1-F4 and F5-F8 had varying amounts of alumina covering agent for each of four formulations: 1.5 phr, 3.0 phr, 4.5 phr, 6.0 phr. The alumina covering agent for formulations F1-F4 was 3,5 Di-tert-butylcatechol (DTBC) and the alumina covering agent for formulations F5-F8 was benzilic acid.

The rubber formulations were prepared by mixing the components given in Table 1, except for the accelerators and sulfur, in a Banbury mixer until a temperature of between 110° C. and 170° C. was reached. The accelerators and sulfur were added in the second phase on a mill. Vulcanization was effected at 150° C. for 45 minutes. The formulations were tested both before and after vulcanization to measure their properties, the results of which are shown in Table 2.

TABLE 2
Physical Properties

| | W1 | W2 | F1 | F2 | F3 | F4 | F5 | F6 | F7 | F8 |
|---|---|---|---|---|---|---|---|---|---|---|
| Green Rubber | | | | | | | | | | |
| Initial Torque, kPa | 234 | 935 | 292 | 235 | 238 | 207 | 291 | 272 | 257 | 255 |
| T20% increase, min. | 1.8 | 0.3 | 1.25 | 0.9 | 0.9 | 1.2 | 0.9 | 1.5 | 0.9 | 1.5 |
| T40% increase, min. | 6.2 | 0.6 | 1.8 | 2.4 | 3.1 | 3.3 | 1.5 | 5.4 | 3.0 | 5.1 |

The results shown in Table 2 for the green rubber properties provide the initial torque and then the amount of time, in minutes, that it took to increase the initial torque by 20% and 40% respectively. The results show that the covering agent considerably slowed the torque increase when compared to the witness formulations, which indicates that the covering agent provides improved scorch and processability of the rubber compositions. The addition of the covering agent reduced the initial torque. The time at T20% and T40% was longer than the witness W2 indicating improved processability and scorch.

### Example 2

This example demonstrates the effect of the alumina covering agent on rubber compositions having a different reinforcing alumina. Rubber compositions were prepared using the components shown in Table 3. The amount of each component making up the rubber compositions are provided in parts per hundred parts of rubber by weight (phr). The components of the rubber formulations are the same as those used in Example 1 except where indicated below.

TABLE 3
Formulations

| | W1 | W3 | F9-F11 | F12-F13 | F14 |
|---|---|---|---|---|---|
| SBR | 100 | 100 | 100 | 100 | 100 |
| Silica | 45 | 0 | 0 | 0 | 0 |
| Alumina | 0 | 74 | 74 | 74 | 74 |
| Silane | 4.5 | 3 | 3 | 3 | 3 |
| Alumina Cover Agent | 0 | 0 | 2.0-7.5 | 2.0-3.0 | 3.0 |
| 6PPD | 2 | 2 | 2 | 2 | 2 |
| DPG | 1.8 | 0 | 0 | 0 | 0 |
| Stearic Acid | 1.2 | 1.2 | 1.2 | 1.2 | 1.2 |
| ZnO | 2.0 | 2.0 | 2.0 | 2.0 | 2.0 |
| CBS | 1.5 | 1.5 | 1.5 | 1.5 | 1.5 |
| Sulfur | 1.5 | 1.5 | 1.5 | 1.5 | 1.5 |

The alumina was AKP-G15 marketed by Sumitomo Chemical and had a BET of 164 m²/g, a mean particle size of 29 nm and had a gamma crystalline phase.

The inventive formulations F9-F11 and F12-F13 had varying amounts of alumina covering agents for each of the formulations; for F9-F11: 2.0 phr, 4.5 phr and 7.5 phr; and for F12-F13: 2.0 phr and 3.0 phr. The alumina covering agent for formulations F9-F11 was 3,5 Di-tert-butylcatechol (DTBC) and the alumina covering agent for formulations F12-F13 was benzilic acid. The alumina covering agent for formulation F14 was a mixture of both: 1.3 phr of DTBC and 1.7 phr of benzilic acid.

The formulations were prepared and tested in the same manner as those of Example 1. The results are shown in Table 4. These results show the same effect on the rubber compositions as was seen in Example 1, i.e., indications of improved processability and scorch.

TABLE 4
Physical Properties

| | W1 | W3 | F9 | F10 | F11 | F12 | F13 | F14 |
|---|---|---|---|---|---|---|---|---|
| Green Rubber | | | | | | | | |
| Initial Torque, kPa | 234 | 2820 | 748 | 583 | 488 | 967 | 848 | 628 |
| T20% increase, min. | 1.8 | 0.9 | 0.9 | 1.95 | 1.95 | 0.45 | 0.9 | 0.9 |
| T40% increase, min. | 6.2 | 2.25 | 1.0 | 3.1 | 5.1 | 0.9 | 1.8 | 1.3 |

### Example 3

This example demonstrates the effect of the alumina covering agent on rubber compositions having a different reinforcing alumina. Rubber compositions were prepared using the components shown in Table 5. The amount of each component making up the rubber compositions are provided in parts per hundred parts of rubber by weight (phr). The components of the rubber formulations are the same as those used in Example 1 except where indicated below.

TABLE 5
Formulations

| | W1 | W4 | F15-F17 | F18-F21 |
|---|---|---|---|---|
| SBR | 100 | 100 | 100 | 100 |
| Silica | 45 | 0 | 0 | 0 |
| Alumina | 0 | 74 | 74 | 74 |
| Silane | 4.5 | 0 | 0 | 0 |
| Alumina Cover Agent | 0 | 0 | 1.5-6.0 | 1.5-6.0 |
| 6PPD | 2 | 2 | 2 | 2 |
| DPG | 1.8 | 0 | 0 | 0 |
| Stearic Acid | 1.2 | 1.2 | 1.2 | 1.2 |
| ZnO | 2.0 | 2.0 | 2.0 | 2.0 |
| CBS | 1.5 | 1.5 | 1.5 | 1.5 |
| Sulfur | 1.5 | 1.5 | 1.5 | 1.5 |

The alumina was Alox-01-NW.005N marketed by American Elements and had a BET of 130 m²/g.

The inventive formulations F15-F17 and F18-F21 had varying amounts of alumina covering agents for each of the formulations; for F15-F17: 1.5 phr, 3.0 phr and 4.5 phr; and for F18-F21: 1.5 phr, 3.0 phr, 4.5 phr and 6.0 phr. The alumina covering agent for formulations F15-F17 was 3,5 Di-tert-butylcatechol (DTBC) and the alumina covering agent for formulations F18-F21 was benzilic acid. The formulations were prepared and tested in the same manner as those of Example 1. The results are shown in Table 6.

TABLE 6
Physical Properties

| | W1 | W4 | F15 | F16 | F17 | F18 | F19 | F20 | F21 |
|---|---|---|---|---|---|---|---|---|---|
| Green Rubber | | | | | | | | | |
| Initial Torque, kPa | 234 | 935 | 453 | 370 | 303 | 777 | 607 | 342 | 314 |
| T20% increase, min. | 1.8 | 0.3 | 0.3 | 0.6 | 1.5 | 0.3 | 0.45 | 3.3 | 3.6 |
| T40% increase, min. | 6.2 | 0.6 | 0.6 | 0.9 | 2.25 | 0.3 | 0.9 | 5.4 | 12.0 |

These results show the same effect on the rubber compositions as was seen in Examples 1 and 2, i.e., indications of improved processability and scorch.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

What is claimed is:

1. A rubber composition based upon a cross-linkable rubber composition, the cross-linkable rubber composition comprising, in parts by weight per 100 parts by weight of rubber (phr):
a diene rubber;
a reinforcing filler comprising a reinforcing alumina filler having a nitrogen surface area of greater than 30 m²/g, wherein the reinforcing alumina filler is at least 25 wt % of the reinforcing filler;
an alumina covering agent selected from the group consisting of a benzilic acid derivative, a catechol derivative, and combinations thereof having structures as follows: 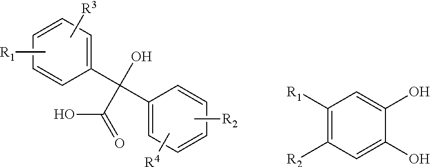
wherein R¹, R², R³, and R⁴ may be the same or different and are selected from a hydrogen, a C₁ to C₈ alkyl group, a C₅ to C₁₈ cycloalkyl group, or a C₆ to C₁₈ aryl group; and
a curing system.

2. The rubber composition of claim 1, wherein R¹ and R³ are separated by at least one carbon on the ring to which they are bonded and R² and R⁴ are separated by at least on carbon on the ring to which they are bonded.

3. The rubber composition of claim 1, wherein the alumina covering agent is benzilic acid, wherein R¹, R², R³, and R⁴ are hydrogen.

4. The rubber composition of claim 1, wherein the alumina covering agent is 3,5 Di-tert-butylcatechol, wherein both R¹ and R² are a t-butyl moiety.

5. The rubber composition of claim 1, wherein the cross-linkable rubber composition includes between 0.5 wt % and 15 wt % of the alumina covering agent based upon a total weight of the alumina reinforcing filler.

6. The rubber composition of claim 1, wherein the reinforcing filler further comprises a secondary filler selected from the group consisting of a silica, a carbon black, and combinations thereof.

7. The rubber composition of claim 1, wherein the reinforcing alumina filler is at least 75 wt % of the reinforcing filler.

8. The rubber composition of claim 7, wherein the reinforcing alumina filler is 100 wt % of the reinforcing filler.

9. The rubber composition of claim 1, wherein the reinforcing alumina filler has a nitrogen surface area of between 30 m²/g and 400 m²/g.

10. The rubber composition of claim 9, wherein the reinforcing alumina filler has a nitrogen surface area of between 80 m²/g and 250 m²/g.

11. The rubber composition of claim 1, wherein the diene rubber is selected from the group consisting of a styrene-butadiene rubber, a polybutadiene rubber, a natural rubber, a synthetic polyisoprene rubber and combinations thereof.

12. The rubber composition of claim 1, wherein the cross-linkable rubber composition includes between 30 phr and 300 phr of the alumina reinforcing filler.

13. The rubber composition of claim 12, wherein the cross-linkable rubber composition includes between 50 phr and 275 phr of the alumina covering agent.

14. The rubber composition of claim 1, wherein the cross-linkable rubber composition includes between 30 phr and 300 phr of the reinforcing filler.

15. The rubber composition of claim 1 wherein the curing system is a sulfur curing system.

16. The rubber composition of claim 1 wherein the curing system is a peroxide curing system.

17. A rubber composition based upon a cross-linkable rubber composition, the cross-linkable rubber composition comprising, in parts by weight per 100 parts by weight of rubber (phr):
a diene rubber;
a reinforcing filler comprising a reinforcing alumina filler having a nitrogen surface area of greater than 30 m²/g, wherein the reinforcing alumina filler is at least 25 wt % of the reinforcing filler;
an alumina covering agent selected from the group consisting of a benzilic acid derivative, a catechol derivative, and combinations thereof having structures as follows: 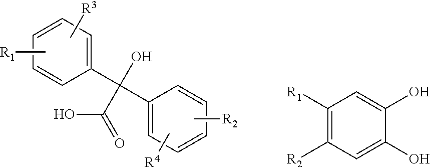
wherein R¹, R², R³, and R⁴ may be the same or different and are selected from a hydrogen, a C₁ to C₈ alkyl group, a C₅ to C₁₈ cycloalkyl group, or a C₆ to C₁₈ aryl group; and
a sulfur or peroxide curing system.

18. The rubber composition of claim 17, wherein R¹ and R³ are separated by at least one carbon on the ring to which they are bonded and R² and R⁴ are separated by at least on carbon on the ring to which they are bonded.

19. The rubber composition of claim 17, wherein the alumina covering agent is benzilic acid, wherein R¹, R², R³, and R⁴ are hydrogen.

20. The rubber composition of claim 17, wherein the alumina covering agent is 3,5 Di-tert-butylcatechol, wherein both R¹ and R² are a t-butyl moiety.
